(19) United States
(12) Patent Application Publication
(10) Pub. No.: US 2022/0108416 A1
(43) Pub. Date: Apr. 7, 2022

(54) SYSTEM AND METHOD FOR MANAGING ON-DEMAND DELIVERY AND PICKUP

(71) Applicant: FIJO Technologies Inc., San Francisco, CA (US)

(72) Inventors: Amrinderpal Singh Oberai, Fremont, CA (US); Abhijit Roy Barman, San Francisco, CA (US); Aamir Sattar, San Francisco, CA (US); Jerry G. Geronimo, Fremont, CA (US); Ashav Kaushik, Greater Noida West (IN); Abhishek Bansal, Kurukshetra (IN); Felix N. Mendoza, III, Sacramento, CA (US)

(21) Appl. No.: 17/495,927

(22) Filed: Oct. 7, 2021

Related U.S. Application Data
(60) Provisional application No. 63/088,812, filed on Oct. 7, 2020.

(51) Int. Cl. G06Q 50/30; G06Q 30/02; G06Q 10/06

(52) U.S. Cl. CPC G06Q 50/30; G06Q 10/06311; G06Q 30/0214

(57) ABSTRACT

A system and method of managing a vehicle pickup, comprises receiving, at a server, a rider request from a rider to be picked up at a selected location at a rider selected time for a fee. One or more candidate drivers are identified to pick up the rider at the selected location, wherein the one or more candidate drivers is located with a present buffer zone of the rider's selected location. An acceptance is received from the first driver of the one or more candidate drivers. At least a portion of the fee is given to the first driver upon detecting that the first driver has picked up the rider at the selected location by the rider selected time.

This application claims the benefit of U.S. Provisional Patent Application Ser. No. 63/088,812 filed Oct. 7, 2020, which is hereby incorporated by reference in its entirety.

### FIELD

The present disclosure relates to a System and Method for Managing On-Demand Delivery and Pickup.

### BACKGROUND

Existing ride sharing applications do not offer guaranteed pickup, do not provide entrusted trip pools, do not offer halt rides and do not allow authentication to ensure the correct rider is getting into the correct driver's car. What is needed is a system and method that performs one or more of the above.

### BRIEF DESCRIPTION OF THE DRAWINGS

FIG. 1 illustrates the secure ride feature of the present system in accordance with an aspect of the present disclosure.

FIG. 2 illustrates a flow chart related to the secure ride method in accordance with an aspect of the present disclosure.

FIG. 3 illustrates a block diagram of the system architecture for the secure ride feature in accordance with an aspect of the present disclosure.

FIG. 4 illustrates the flow diagram of the ensured pickup workflow in accordance with an aspect of the present disclosure.

FIG. 5 illustrates the whole tried feature of the system in accordance with an aspect of the present disclosure.

FIG. 6 illustrates a flow diagram of the trusted pool feature of the system in accordance with an aspect of the present disclosure.

FIG. 7 illustrates a flow diagram of the trusted pool feature of the system in accordance with an aspect of the present disclosure.

FIG. 8 illustrates a block diagram of the system architecture in accordance with an aspect of the present disclosure.

### DETAILED DESCRIPTION

The present system and method is configured to allow Riders and Drivers to connect via the system and transact a ride or trip therethrough. The Rider can type in a date and time (pickup time) for the Driver to be at a specific pickup location. The system will use a Value Time Value (e.g. 30 minutes from pickup time as time that the Rider is willing to wait) to calculate an Offer's expiration time.

Regarding location information, the Rider can type in specific valid addresses in an aspect. Rider can set a default location in his/her profile in an aspect. This can include the Rider's Home address, Office Address, work or other locations saved by the Rider. Regarding the Rider's destination, Rider's current location can be a default location in an aspect. In another aspect, Rider can view and select one or more predesignated points-of-interest. In an aspect, the Rider can type in the desired destination address into the system.

The system and method allows the Driver and Rider to agree on an offer amount. The offer amount can include the price that the rider is willing to pay the Driver. In an aspect, the Driver can choose which Offer to accept from the Offers' list. In an aspect, the Rider can view the “Suggested average fare” price in the local currency. In an aspect, the Rider is presented with an adjusted Offer price which may include a connection fee as well as other fees where applicable (e.g. tolls, service fees at airports, parking lots, government fees). In aspect, all payments are Pre-Authorized by the Driver and/or the Rider. Upon approval by the Rider, the Offer Price will be visible to all Drivers within a set driving service radius of the Rider.

In an aspect, the system takes into account Rider Wait Time or a selected rider time, the time the Rider is willing to wait after submitting an offer. This time value is factored into the Driver's pickup logistics in an aspect.

With regard to the Driver Service Radius or Driving Radius, the system takes into account the following. In an aspect, the default center of the radius is the Driver's current location, although the Driver can change the center to another area. In an aspect, Driver specifies a radius (miles/km) around the center that s/he wants to drive. In an aspect, the Driving radius can be configured to be flexible and can be based on a tiered driver qualifying metric. In an aspect, the Driver will need to meet specific qualifying requirements to specify and expand preferred service area for pickups and drop-offs. In an aspect, the Driver can view only the Offers within his/her driving service radius with or without a buffer radius set by the system. The buffer radius can be adjusted or modified for Drivers to see Offers from across the street or around the block of service radius, and uses artificial intelligence or other analytics to include areas which the Driver may be interested in. In an aspect, Drivers with higher ratings can adjust the buffer driving radius to their choice.

In an aspect, the system can be set with certain rules which can be changed, deleted or modified by the system administrator. For example, it may be contemplated that the Driver cannot change his/her driving service radius after accepting an Offer, until the Rider is dropped off and/or until the Rider exits the vehicle. The Driver will have total control on which Offer to accept. In an aspect, the Driver may choose from a list of active Offers from different Riders; choose Offers within his/her driving service radius; and/or accept one Offer at a time within the driving service radius. In an aspect, multiple drivers can accept the same Offer from the same Rider, but it will be up to the Rider to select the Driver. In aspect, the system is configured such that when a Driver and a Rider are paired (connected or matched), the other drivers are free to accept other Offers. In an aspect, the Driver is notified for any changes made to the Ride by the Rider. For the Rider, the system can have an option that can be set by the Rider to automatically choose a Driver (when more than one driver is available). When unable to select a driver, the Rider will have the option to resubmit or cancel the Offer. The system can be configured to cause the Rider's Offer to expire within a predetermined time after it is submitted. In an aspect, the system allows the Rider to submit one or more Offers at a time or until the current ride is completed. In aspect, the Rider is notified in real time when the Driver starts driving to the pick-up location.

### Secure Ride

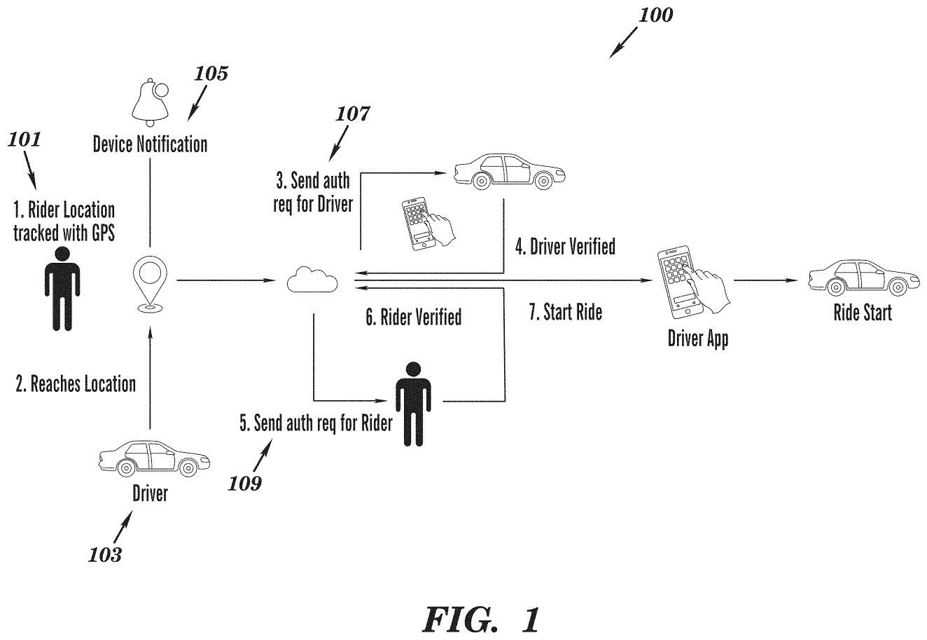

FIG. 1 illustrates the secure ride feature of the present system in accordance with an aspect of the present disclosure. As shown in FIG. 1, a rider's location is tracked by their mobile phone, whereby the system identifies where the location of the rider is 101. Once the driver 103 accepts a secure driver offer and approaches the location of the rider 103, the rider's device gets notified 105. The system then sends a driver authorization request to the driver 107 and the system sends a rider authorization request to the rider 109.

In an aspect, when Driver and Rider are paired, AI modelling is used to ensure proper credentials are verified and confirmed at pickup location prior to Rider entering the vehicle. System reasonably minimizes false-pickups (pickup wrong person) and/or unauthorized Drivers. In an aspect, the system is configured to offer secure riders and drivers to the users. When reserving a private car for travel or joining a shared ride, users do have a reservation about their fellow travelers, whether it be Rider or Driver. The system can be configured to solve this issue by authenticating the users using their biometric information from their mobile devices.

Users get to choose the option of taking secure rides, requesting them to set and authenticate their ID's through device biometrics in compliance with privacy laws and regulations. When a Rider chooses to utilize the secure ride feature, the Rider will also need to set their own identity and authenticate themselves for each secure ride. Once the Driver reaches the pickup location, then before seating into the cab, the Rider has to verify the driver through biometric (Face ID/Fingerprint Sensor). In an aspect, when Drivers see the secure rider offer, it will come with a special icon and with an optionally increased ride amount. In an aspect, when a Driver accepts this offer then, on reaching the pickup point, the Driver must verify the rider through biometric (Face ID/Fingerprint Sensor). After the verification completes, the Rider gets confirmation to enter the cab. Once the Rider confirms their identity, the Driver gets an option to start the ride.

In registering with the system, the Rider will be asked to register the biometric (Face ID/Fingerprint Sensor) for the secure ride feature. In an aspect, when the Driver reaches the rider's pickup location and confirms that he has reached the pickup point by Location navigation from the device GPS, then a notification will be sent to the rider's device informing that their ride has arrived. After getting the notification, the rider has to arrive at a designated pickup point, which is the location of the rider using the device GPS of the Rider. When the Rider reaches within the preset range (e.g. 10 meters) to the pickup point, Riders will be asked to authenticate the secure ride, without authentication the driver will not let the rider take the ride.

When the driver launches the application for the very first time the system will ask the driver to register. After successful registration the driver data will be evaluated and verified by the system or by individuals managing the system. Once the evaluation is successfully done then the driver will be asked to register and provide their biometrics information in the app to be eligible for the secure ride feature.

Entity will be asked by a mobile application to authenticate using the mobile biometrics (Finger/Face detection). In an aspect, no data will be saved in the system for fingerprint/face authentication. The device hardware will be used to authenticate the user as the standard secured process of authentication. Once the device authentication is successful the acknowledgement will be sent to the system along with a token in encrypted format by using public key. The system authenticates the Rider or Driver by matching the same token saved at backend after encrypting it with a public key. If encryption matches, then the system sends and acknowledges back to the system that the entity is identified. Once the Driver authentication is successfully done, then only the Driver will be able to start the ride.

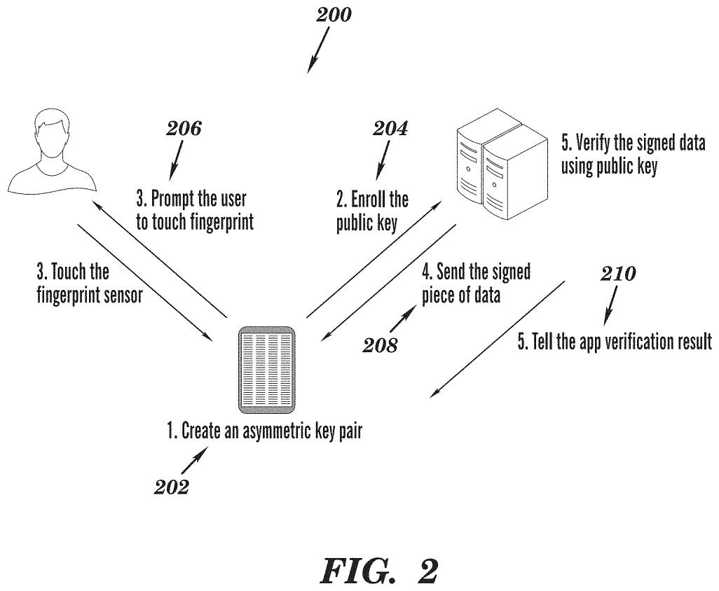

FIG. 2 illustrates a flow chart related to the secure ride method in accordance with an aspect of the present disclosure. In an aspect, the system utilizes asymmetric cryptography for biometric authentication. This cryptographic system uses pairs of public keys which may be disseminated widely, and private keys which are known only to the owner 202. One of the properties of this system is that a sender can use its private key to sign a message and this signature can be verified by anyone who has access to the sender's public key. This verification proves that the sender had access to the private key, and therefore the sender identifies its identity.

To implement the Face ID/Fingerprint Sensing, Enrollment and Authentication are performed. During enrollment, a public and private key pair are created and stored in the phone's secure, Hardware-backed, keystore 204. In an aspect, the system instructs the phone's OS to only open this keystore if the user identifies itself, the public key is sent to the system. To get the encoded byteArray of the public key, the system encodes this byteArray with base64 encoding and converts it into a PEM format. This format can be sent as a string to the server in an aspect. For authentication, the system will prompt the user to authenticate him or herself using biometric authentication (Face ID/Fingerprint Sensor) 206. If the authentication is successful, the system will get access to the keystore, which contains the generated public key and private key. Once the system has access to the keystore, the system will sign the access token with the key and send it to the system 208, whereby the system will verify the signup data and respond back that the user is authorized/identified 210. In an aspect, the system will use biometrics to make a server call where necessary. The token (Server Token) is required for later calls to the server and needs to be stored on the device. When a user logs in to the system for the first time the token is called in the keychain. When the user subsequently logs into the app, the user can use the biometric functions on their device to authenticate themselves and move straight into the app. Since the system has the token, this can be used later in the user session.

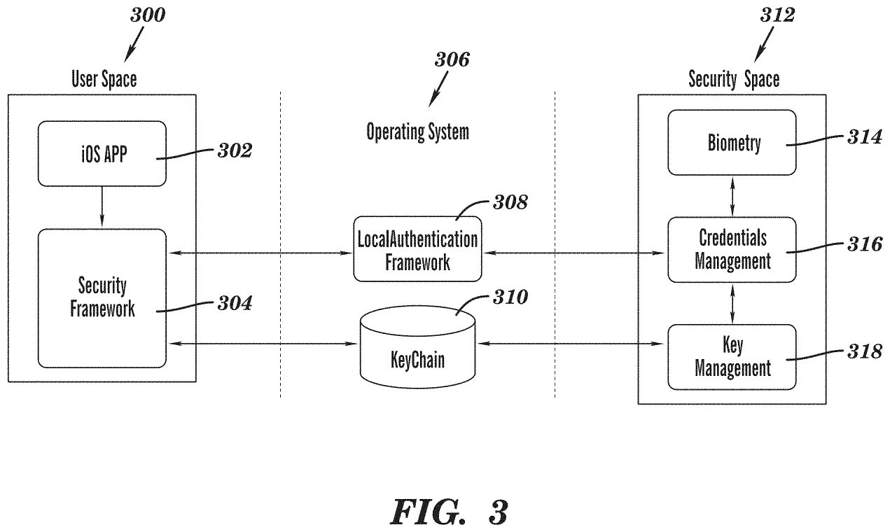

FIG. 3 illustrates a block diagram of the system architecture for the secure ride feature in accordance with an aspect of the present disclosure. As shown in FIG. 3, the user space 300 includes a mobile device app 302, and a security framework component 304. An operating system 306 includes a local Authentication framework 308, and a keychain 310. The security space 312 includes a biometric component 314, a credentials management component 316, and a key management component 318. As shown in FIG. 3, the local authentication framework 308 communicates with the security framework 304 and the credentials management component 316. As shown in FIG. 3, the keychain 310 communicates with the security framework 304 and the key management component 318.

### Ensured Pickup

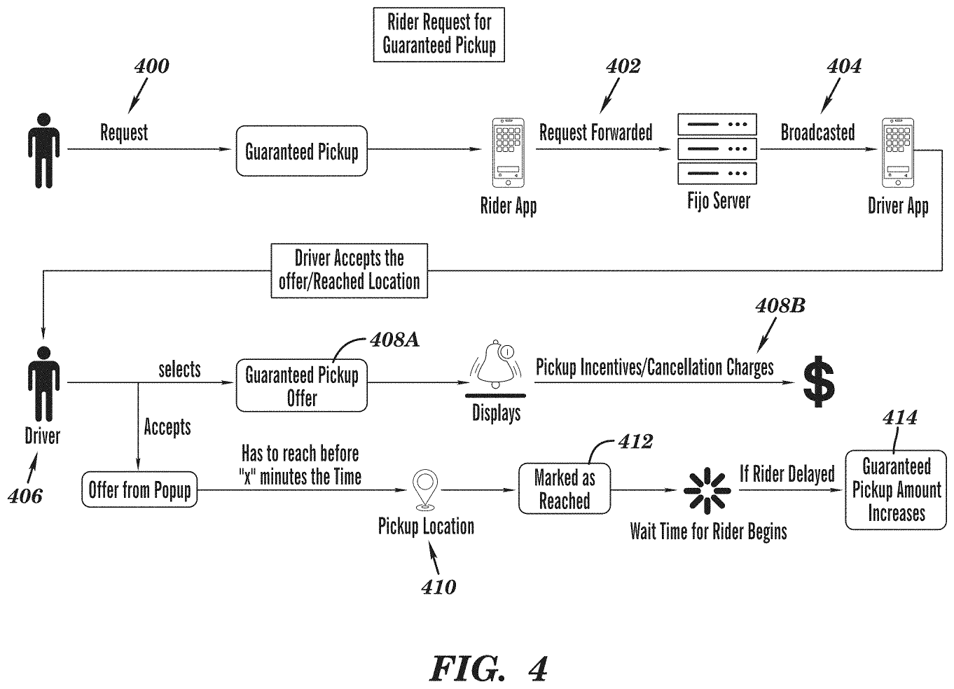

FIG. 4 illustrates the flow diagram of the ensured pickup workflow in accordance with an aspect of the present disclosure. In an aspect, the system is configured to ensure that the Rider will be picked up by a Driver after the Rider has put in a pickup request. In an aspect, the ensure pickup is enabled with a toggle button and can also be disabled by the Rider and/or Driver 400. In an aspect, the system can be configured to add an ensured pickup fee when this feature is enabled, whereby the Driver may receive a percentage of the fee. In an aspect, the system is configured with a cancellation feature in which the Rider is penalized a percentage of the ensured pickup fee. In an aspect, the Driver has to pay if the cancellation was done from the Driver side. The system can be configured to have the ensure pickup fee to be fixed or a variable amount. The system can be configured to have the following: amount of pickup fee will be added to the rider ride fare; amount of pickup fee depends on the type of vehicle that Rider picks (luxury vs. economy; closer vs. further).

In an aspect, Rider requests for an ensured pickup ride on the system by using the system's user interface 400. Once the Rider inputs all necessary information, including enabling the ensured pickup ride on the application, the offer is sent to all potential Drivers in the buffer radius of the Rider 402, 404. The offer will be visible to all eligible drivers and may include an ensured pickup icon or other identifying marking indicating the ensured pickup 406. If a driver selects that ensured pickup offer, then a pop up box may appear on Driver's screen showing pickup incentive and the other terms like cancellation charges for ride. If the driver accepts the offer from the popup then the driver has to reach the pickup location, before (X minutes) the requested time 408. On reaching the pickup location the driver will mark him/her as reaching the intended destination 410. When the driver reaches the pickup location, then the waiting time for the rider will start and if the rider is not able to take the ride within wait time 412, the ensured pickup amount charge will increase with the increase in delay 414.

Driver will get an option of cancellation after (Y minutes) of waiting as this is a guaranteed pickup ride then the driver will get the incentive for guaranteed pick as we will consider that the rider will not be willing to go, whereby the Rider we will be charged an additional amount. If the driver cancels the ride before (Y minutes) or if unable to reach before the requested time then the driver will be penalized. In an example, the fine will vary from 50%-100% of the pickup incentive. In an aspect, the amount of the fine may depend upon how soon the driver is able to notify about the cancellation, to allow the system to send the request to the next nearest possible driver. Any delay or cancellation in ensured pickup mode will be eligible for a refund and/or reward calculated on the basis of original incentive charged from the rider. In this case the system can assign the same ride to a second driver, and the same process will be applied to the second driver, whereby the rider will get a compensation either in the form of reward or in the form of reduction in the ensured pickup fee. Incentive amount will depend on the distance and the time of the ride (Peak hour and non-peak hours) and may include weighted or unweighted factors including, but not limited to, total distance, total time of ride, day or night, weather, traffic, current driver or rider availability and the like.

### Halt Ride Feature

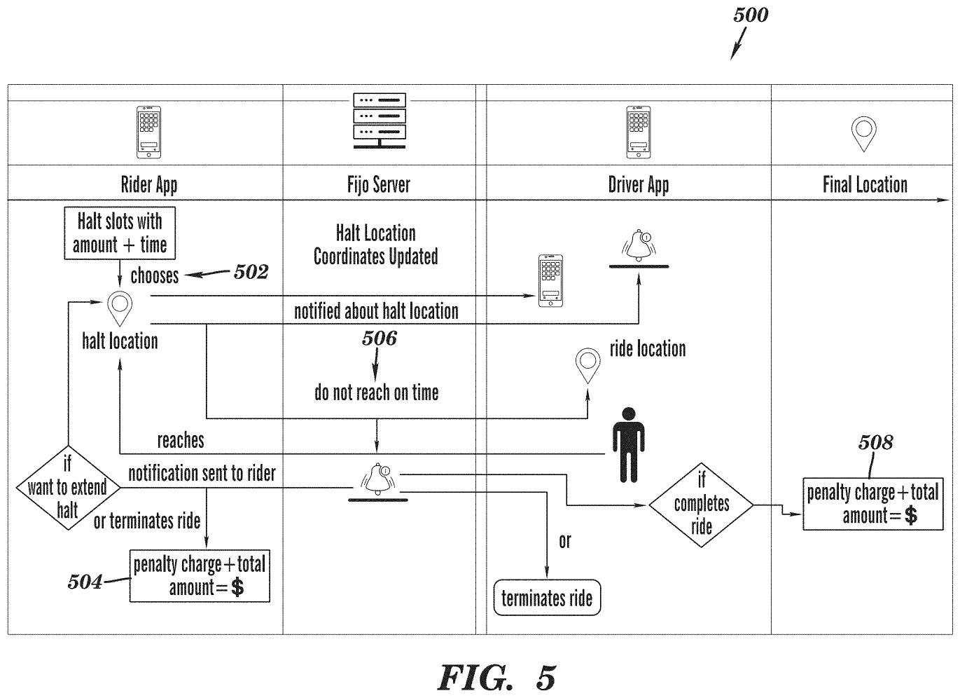

FIG. 5 illustrates the whole tried feature of the system in accordance with an aspect of the present disclosure. In an aspect, the system is configured with a Halt Sequence feature which provides riders an option to add a halt period within their current trip before reaching the final destination. The system will provide a list of halt slots available to a rider with the amount and time associated with it 502. If the rider books the layover from the slot then the respective amount will be added to the final ride fare cost. The cost analysis of the halt slots will be calculated by the system based on the rider's route, halt time, updated distance as well as other factors.

In an aspect, as soon as the rider starts its journey he/she can have the option of picking the halt slots from the given list of halts by the system. In an aspect, one or more halt spots are chosen by the rider, whereby the rider drops a pin on a map or enters an address or point of interest and the system automatically updates the trip to include the chosen halt spot(s) 504. The Halt can be selected before the ride starts. The Halt can be selected after the ride starts, wherein the halt location can be in a range of X km or miles from its current route. The displacement from the original route can be capped for the halt location to be chosen. If the Rider updates any halt spots from the given list, the system can update the driver via push notification, in an aspect, In an aspect, the driver can receive and update through the current map coordinates containing a path from source to destination via halt coordinates 506. The system can then update the final ride cost for a given rider based on its initial ride cost+halt cost via a ride halt algorithm. In aspect, an additional cost can be charged if the rider extends the time slots assigned to him or completes the rider's trip on a halt location. In an aspect, the system calculates that halt sequence and may include weighted or unweighted factors including, but not limited to, total distance, total time of ride, day or night, weather, traffic, current driver or rider availability, total time that the driver is stopped at the halt stops, the halt rider constant price per min. The driver's wage includes one or more of the above factors as well. In an aspect, there is an option to set/add a halt period within the ride. In an aspect, there can be a list of halts slots available to a particular rider with the amount and time shown to the rider. If the rider books the layover from the slot then the respective amount will be added to the ride fare. The halt slot can be calculated by the system based on the rider route, start point and end point, area, city, and state. If the rider adds a halt in his ride then the same will be updated in the driver app via a push notification. If a rider is not able to come back to the ride within the halt slot then the ride will get a notification asking if s/he wants to extend the halt time or will s/he want to complete the ride. If the rider chooses to extend the halt time then, again s/he will have to select from the halt slot and the charge will be updated accordingly, same will be updated to the driver as well. If the rider doesn't respond to notification and comes back before the next time slot then s/he will be charged on a pro rata basis. If the rider selects to complete the ride then the penalty charge will be added to the ride amount, at the same time the driver will be notified to complete the ride 508. If the rider arrives early within the time then the rider will mark in the app that s/he has arrived. Once he does that then the driver can start the ride and complete the ride. there will be no discount provided in this case)

In an aspect, the Driver will be notified about the halt via a push notification from the server of the system. When Rider adds layover then on the driver app the halt location coordinates will be updated on the driver navigation view in driver's application. Once the driver reaches the halt location coordinates then the driver has to mark as reached at halt point by tapping on a button in the driver app. When the driver enables the halt, a timer for the rider will be started and the rider has to come back to the ride within the time slot. If a rider is not able to reach the ride within the halt time then the driver will have options to complete the ride there or to start the ride and reach the destination. If the driver completes the ride then fare will be calculated according to that distance travelled adding the layover time and a penalty of a particular amount will be charged from rider and given to the driver.

### Trusted Pool Feature

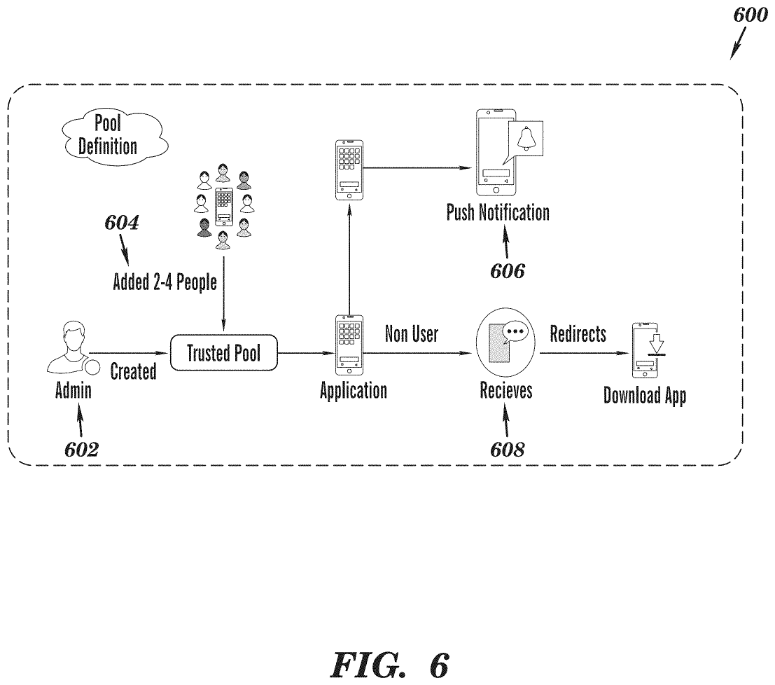

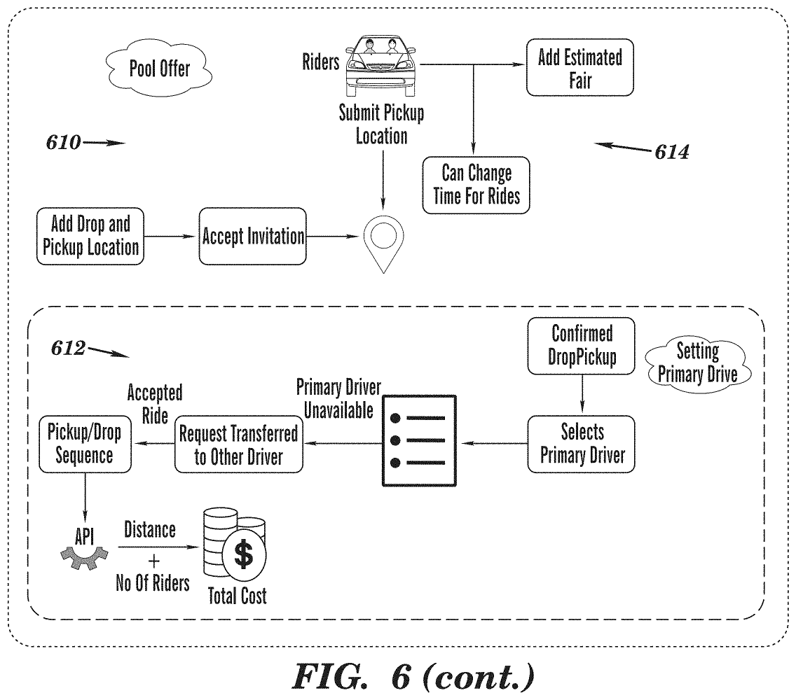

FIG. 6 illustrates a flow diagram of the trusted pool feature of the system in accordance with an aspect of the present disclosure. In an aspect, the system includes a trusted pool feature. In an aspect, two or more known riders ride together from different pickup and drop locations in the driver's vehicle. The system identifies and ensures that all the riders know and trust each other in a pool. Rider has to create a pool ride by selecting the contact people and thus creating a trusted pool 602. The person who creates the trusted pool is the admin to this trusted pool. On creating the trusted pool admin user can add any number of additional people in that particular pool 604. Users will select contact details, and if the user's account exists from those numbers they will get a push notification 606, else they will get a text message for invitation redirecting them to download the app 608. The ride will remain still in the hold state and is not offered to the driver, until all invited riders accept it and submit their pick up location. Once all locations are confirmed, the ride goes out on the offer list to be picked by drivers. For other riders they have to add their pickup and drop point before they accept the pool invite. Only the admin has the rights to modify the list of pooling users. Pool requests will be triggered manually on a daily basis only for that pool and can change the time or users based on their availability. Riders will be able to enter the estimated fare for the ride.

There will be an option to set the primary driver in the riders application. Once the primary driver is set then that driver will get notified with the details of the ride for which driver is set as primary. When a pool is created then we will check for the availability of the primary driver. If a driver is not available then we will send this ride request to another driver for that particular ride.

For the Driver, once the pool is created it will get listed under offers to the driver 610. Once a driver accepts the offer then the route will be calculated based on the nearest pickup points using the system's API in which a drop sequence will be calculated 612. There is a total cost to the Ride depending upon the Ride Distance and number of riders. The amount gets deducted based on the distance travelled and the type of ride and it will be calculated on an individual user basis.

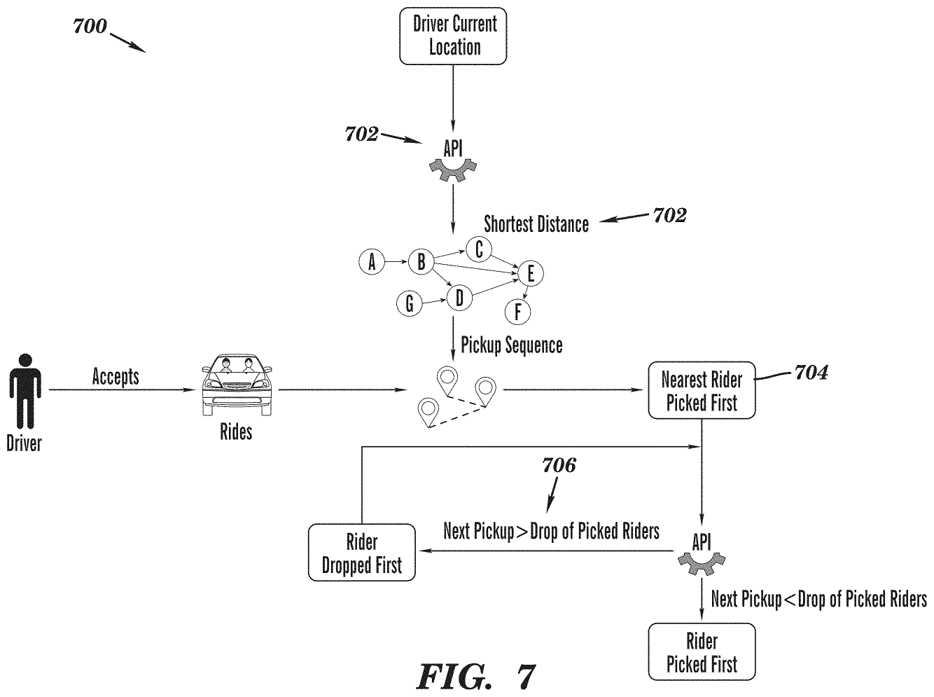

FIG. 7 illustrates a flow diagram of the trusted pool feature of the system in accordance with an aspect of the present disclosure. Once the driver accepts the ride then we will calculate the pickup sequence based on the driver's current location and the pickup locations 702. Once the rider gets picked up then the system will calculate the rider's drop location and pickup location of the next rider 704. If the picked up rider's drop comes on the way to the next picking driver then we will be dropping the rider first 706. In an aspect, the system's API will calculate the distance and will provide the shortest path for all the coordinates provided. The nearest rider will be picked up first 706. In an aspect, the system does a latitude longitude comparisons for getting the pickup sequence.

Trusted Pool Fare calculation will depend on the distance and the time of the ride (Peak hour and non-peak hours) and may include weighted or unweighted factors including, but not limited to, total distance, total time of ride, day or night, weather, traffic, current driver or rider availability and the like. In an aspect, the driver Incentive can be based off of one or more of: Base Fare; Total Distance Price; Total Time Price; Day Night Time Factor; and/or Current Ride Availability factor. This can be calculated for each and every Passenger/Rider in that ride. Riders can mark any of the drivers as the trusted driver. Marked trusted drivers will be fixed for the particular rider, route and timing. When the rider has to book the ride for the same time and the same route then that trusted driver will be offered the ride first for the pickup. There will be an option to mark it as a holiday(s) for riders so that on those days we can assign some other rides to that driver.

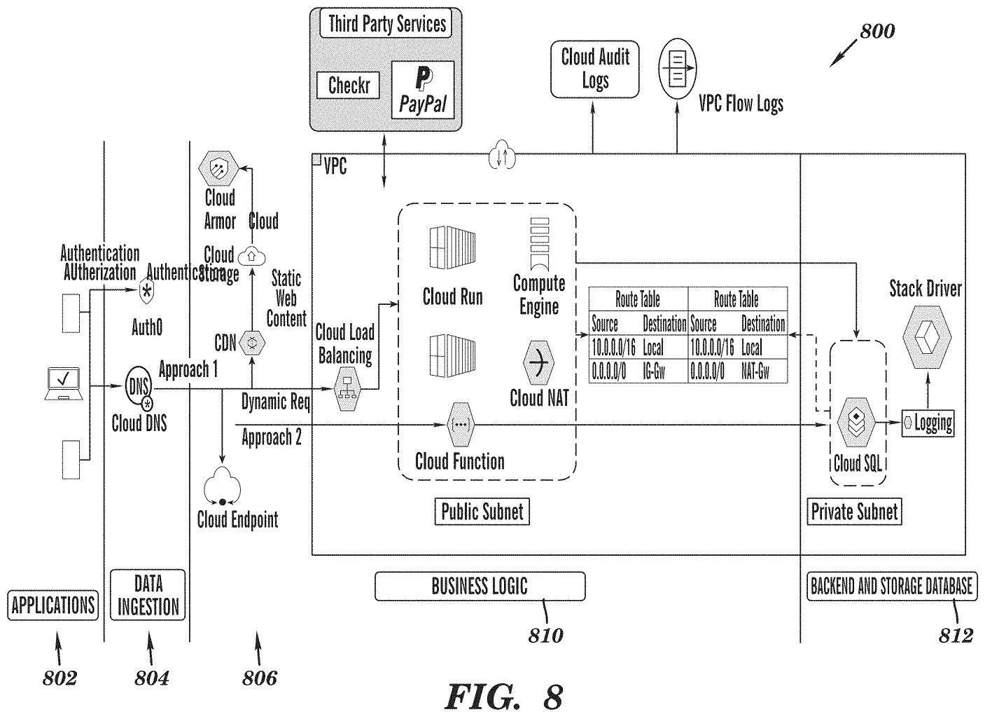

FIG. 8 illustrates a block diagram of the system architecture in accordance with an aspect of the present disclosure. Referring to FIG. 8, the computing apparatus or system 800 may perform any number of functions described above. The system 800 includes one or more client applications 802, a data ingestion component 804, a cloud endpoint 806, a business logic module 808 and a storage component 810. The computing apparatus or system includes one or more processors, a memory, and/or a communication interface, which are coupled together by a bus or other communication link, although the computing apparatus can include other types and/or numbers of elements in other configurations. The processor(s) of the computing apparatus may execute programmed instructions stored in the memory of the computing apparatus for any number of the functions identified above. The processor(s) of the computing apparatus may include one or more CPUs or general purpose processors with one or more processing cores, for example, although other types of processor(s) can also be used. The memory of the computing apparatus stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory.

Accordingly, the memory of the computing apparatus can store one or more applications that can include computer executable instructions that, when executed by the computing apparatus, cause the computing apparatus to perform actions, such as to transmit, receive, or otherwise process messages, for example, and to perform other actions described and illustrated with reference to the above disclosure. The application(s) can be implemented as modules or components of other applications. Further, the application(s) can be implemented as operating system extensions, modules, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the computing apparatus itself, may be located in virtual server(s) running in a cloud-based computing environment rather than being tied to one or more specific physical network computing devices. Also, the application(s) may be running in one or more virtual machines (VMs) executing on the computing apparatus. Additionally, in one or more embodiments of this technology, virtual machine(s) running on the computing apparatus may be managed or supervised by a hypervisor.

The communication interface of the computing apparatus operatively couples and communicates between the computing apparatus, the server devices, and/or the client devices, which are all coupled together by the communication network(s), although other types and/or numbers of communication networks or systems with other types and/or numbers of connections and/or configurations to other devices and/or elements can also be used. By way of example only, the communication network(s) can include local area network(s) (LAN(s)) or wide area network(s) (WAN(s)), and can use TCP/IP over Ethernet and industry-standard protocols, although other types and/or numbers of protocols and/or communication networks can be used. The communication network(s) in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. The communication network(s) can also include direct connection(s) (e.g., for when a device illustrated in FIG. 1, such as the computing apparatus, one or more of the client devices, or one or more of the server devices operate as virtual instances on the same physical machine).

While the computing apparatus is illustrated in this example as including a single device, the computing apparatus in other examples can include a plurality of devices or blades each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the computing apparatus.

Additionally, one or more of the devices that together comprise the computing apparatus in other examples can be standalone devices or integrated with one or more other devices or apparatuses, such as one of the server devices, for example. Moreover, one or more of the devices of the computing apparatus in these examples can be in a same or a different communication network including one or more public, private, or cloud networks, for example.

Each of the server devices in this example may include one or more processors, a memory, and a communication interface, which are coupled together by a bus or other communication link, although other numbers and/or types of network devices could be used. The server devices in this example process requests received from the client devices via the communication network(s) according to the HTTP-based application RFC protocol, for example. Various applications may be operating on the server devices and transmitting data (e.g., files or Web pages) to the client devices via the computing apparatus in response to requests from the client devices. The server devices may be hardware or software or may represent a system with multiple servers in a pool, which may include internal or external networks.

Although the server devices are illustrated as single devices, one or more actions of each of the server devices may be distributed across one or more distinct network computing devices that together comprise one or more of the server devices. Moreover, the server devices are not limited to a particular configuration. Thus, the server devices may contain a plurality of network computing devices that operate using a master/slave approach, whereby one of the network computing devices of the server devices operate to manage and/or otherwise coordinate operations of the other network computing devices. The server devices may operate as a plurality of network computing devices within a cluster architecture, a peer-to-peer architecture, virtual machines, or within a cloud architecture, for example.

Thus, the technology disclosed herein is not to be construed as being limited to a single environment and other configurations and architectures are also envisaged. For example, one or more of the server devices can operate within the computing apparatus itself rather than as a stand-alone server device communicating with the computing apparatus via the communication network(s). In this example, the one or more server devices operate within the memory of the computing apparatus.

The client devices in this example include any type of computing device that can receive, render, and facilitate user interaction with a webtop, such as mobile computing devices, desktop computing devices, laptop computing devices, tablet computing devices, virtual machines (including cloud-based computers), or the like. Each of the client devices in this example includes a processor, a memory, and a communication interface, which are coupled together by a bus or other communication link, although other numbers and/or types of network devices could be used.

The client devices may run interface applications, such as standard Web browsers or standalone client applications, which may provide an interface to make requests for, and receive content stored on, one or more of the server devices via the communication network(s). The client devices may further include a display device, such as a display screen or touchscreen, and/or an input device, such as a keyboard for example.

Although the exemplary system with the computing apparatus, server devices, client devices, and communication network(s) are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the computing apparatus, server devices, or client devices, for example, may be configured to operate as virtual instances on the same physical machine. In other words, one or more of the computing apparatus, client devices, or server devices may operate on the same physical device rather than as separate devices communicating through communication network(s). Additionally, there may be more or fewer computing apparatus, client devices, or server devices than illustrated in the above figures. The client devices could also be implemented as applications on the computing apparatus itself as a further example.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples.

The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof. The examples may also be embodied as one or more non-transitory computer readable media having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the present disclosure. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method of managing a vehicle pickup, comprising:
receiving, at a server, a rider request from a rider to be picked up at a selected location at a rider selected time for a fee;
identifying one or more candidate drivers to pick up the rider at the selected location, wherein the one or more candidate drivers is located with a present buffer zone of the rider's selected location;
receiving an acceptance from a first driver of the one or more candidate drivers; and
awarding at least a portion of the fee is given to the first driver upon detecting that the first driver has picked up the rider at the selected location by the rider selected time.

2. The method of claim 1 further comprising detecting that the first driver has not picked up the rider by the selected time, wherein a percentage is deducted from the fee.

3. The method of claim 1 further comprising detecting that the rider was not at the selected location when the driver arrived at the selected location, wherein a percentage of the fee is added and charged to the rider.

4. The method of claim 1, wherein a secure ride feature is enabled, the method further comprising:
performing an authentication sequence on the rider;
performing an authentication sequence on the driver;
determining a match of the rider and the driver for the trip; and
notifying the rider that the driver is identified.

5. The method of claim 1 further comprising:
receiving an instruction from the rider to include one or more halt stops between the selected location and the destination location;
notifying the driver of the one or more halt stops and providing driving directions to the one or more halt stops;
awarding an additional fee upon determining that the driver's vehicle has reached the one or more halt stop within a selected amount of time.

6. The method of claim 1 wherein the driver further comprises, a first rider having a first mobile device, a second rider having second mobile device and a third rider having a third mobile device, wherein the first, second and third riders are designated in a trusted pool, wherein the driver can only pick up the first, second and third together in one ride trip.

7. A system configured to manage a vehicle pickup, the system comprising:
a memory containing tangible media containing instructions; and
a processor coupled to the memory and upon executing the instructions, causes the processor to:
receive a rider request from a rider to be picked up at a selected location at a rider selected time for a fee;
identify one or more candidate drivers to pick up the rider at the selected location, wherein the one or more candidate drivers is located with a present buffer zone of the rider's selected location;
receive an acceptance from a first driver of the one or more candidate driver;
award at least a portion of the fee is given to the first driver upon detecting that the first driver has picked up the rider at the selected location by the rider selected time.

8. The system of claim 7 wherein the processor detects that the first driver has not picked up the rider by the selected time, wherein a percentage is deducted from the fee.

9. The system of claim 7 wherein the processor is configured to detect that the rider was not at the selected location when the driver arrived at the selected location, wherein a percentage of the fee is added and charged to the rider.

10. The system of claim 7, wherein a secure ride feature is enabled, the system further comprises the processor configured to:
perform an authentication sequence on the rider;
perform an authentication sequence on the driver;
determine a match of the rider and the driver for the trip; and
notify the rider that the driver is identified.

11. The system of claim 7 wherein the processor is configured to
receive an instruction from the rider to include one or more halt stops between the selected location and the destination location;
notify the driver of the one or more halt stops and providing driving directions to the one or more halt stops; and
award an additional fee upon determining that the driver's vehicle has reached the one or more halt stop within a selected amount of time.

12. The system of claim 7 wherein the driver further comprises, a first rider having a first mobile device, a second rider having second mobile device and a third rider having a third mobile device, wherein the first, second and third riders are designated in a trusted pool, wherein the driver can only pick up the first, second and third together in one ride trip.

13. A tangible media containing instructions, which when performed by a processor performs a method comprising:
receive a rider request from a rider to be picked up at a selected location at a rider selected time for a fee;
identify one or more candidate drivers to pick up the rider at the selected location, wherein the one or more candidate drivers is located with a present buffer zone of the rider's selected location;
receive an acceptance from a first driver of the one or more candidate driver;
award at least a portion of the fee is given to the first driver upon detecting that the first driver has picked up the rider at the selected location by the rider selected time.

14. The software of claim 13 wherein the processor detects that the first driver has not picked up the rider by the selected time, wherein a percentage is deducted from the fee.

15. The software of claim 13 wherein the processor is configured to detect that the rider was not at the selected location when the driver arrived at the selected location, wherein a percentage of the fee is added and charged to the rider.

16. The software of claim 13 wherein a secure ride feature is enabled, the system further comprises the processor configured to:
perform an authentication sequence on the rider;
perform an authentication sequence on the driver;
determine a match of the rider and the driver for the trip; and
notify the rider that the driver is identified.

17. The software of claim 13 wherein the processor is configured to
receive an instruction from the rider to include one or more halt stops between the selected location and the destination location;
notify the driver of the one or more halt stops and providing driving directions to the one or more halt stops; and
award an additional fee upon determining that the driver's vehicle has reached the one or more halt stop within a selected amount of time.

18. The software of claim 13 wherein the driver further comprises, a first rider having a first mobile device, a second rider having second mobile device and a third rider having a third mobile device, wherein the first, second and third riders are designated in a trusted pool, wherein the driver can only pick up the first, second and third together in one ride trip.
